(19) United States
(12) Patent Application Publication
(10) Pub. No.: US 2026/0222204 A1
(43) Pub. Date: Jul. 30, 2026

(54) ENCRYPTED LAYERED AUTHENTICATION INTELLIGENCE (ELAI) UNIVERSAL CRYPTOGRAPHIC TRUST VERIFICATION PROTOCOL

(71) Applicant: Jesse Loflin, Franklin, TN (US)

(72) Inventor: Jesse Loflin, Franklin, TN (US)

(73) Assignee: AmericaFirst4Us, Inc., Franklin, TN (US)

(21) Appl. No.: 19/572,739

(22) Filed: Mar. 19, 2026

Related U.S. Application Data
(63) Continuation-in-part of application No. 17/085,257, filed on Oct. 30, 2020.

(51) Int. Cl. H04L 9/32; H04L 9/00

(52) U.S. Cl. CPC H04L 9/321; H04L 9/3236; H04L 9/50

(57) ABSTRACT

A method and system for cryptographic trust verification between entities, wherein each entity possesses a cryptographic hash derived from and inseparable from its own identity. A verification membrane comprising an Encrypted Layered Authentication Intelligence (ELAI) layer is positioned between any two entities as a neutral verification space belonging to neither. Each entity independently presents its hash to the verification membrane. The membrane resolves to verified when both hashes are presented for a common event, and unverified otherwise. Verification is event-specific, temporally bound, non-persistent, and transport-agnostic, functioning identically across any communication medium and between any combination of entity types including persons, devices, autonomous systems, organizations, and future constructs. The invention extends the peer-to-peer sharing platform implementation disclosed in parent application Ser. No. 17/085,257 to define the universal verification protocol underlying all entity-to-entity trust events.

Related Application: This application is a continuation-in-part of U.S. patent application Ser. No. 17/085,257, filed Oct. 30, 2020, “Integrated Social Networking Mobile Application with Ride Sharing,” the entire disclosure of which is incorporated herein by reference.

### FIELD OF THE INVENTION

This invention relates to cryptographic authentication and trust verification systems, and more particularly to a universal protocol for establishing cryptographic trust between any two entities through independent presentation of cryptographic hash values to a neutral verification membrane, applicable across all transport layers and entity types.

### BACKGROUND

The parent application, U.S. application Ser. No. 17/085,257 (“the parent application”), discloses an integrated social networking mobile application with ride-sharing functionality. In that application, users engage in peer-to-peer resource-sharing transactions facilitated by a backend server. The parent application describes an Encrypted Layered Authentication Intelligence (ELAI) verification layer used to establish trust between platform participants, particularly between drivers and passengers in a ride-sharing context.

Specifically, the parent application discloses:
ELAI as a verification component within a sharing-economy platform;
Hash-based identity verification where users are assigned cryptographic hashes derived from their identity data (parent specification);
Bilateral trust resolution between two parties (driver and passenger) presenting credentials to the system;
Default-zero trust state requiring verification per interaction;
Co-location and proximity verification using GPS, Bluetooth Low Energy (BLE), near-field communication (NFC), and QR code exchange;
Device-based interaction where mobile computing devices hold and present user credentials;
Asset custody transfer in the context of shared vehicles or rentals; and
Multi-layer cryptographic processing used to generate and verify user credentials.

The parent application demonstrates a working implementation of ELAI within a specific application domain: ride-sharing and sharing-economy transactions between natural persons using mobile devices.

During continued development and deployment of the platform described in the parent application, the inventor recognized that the ELAI verification layer is not inherently limited to sharing-economy transactions between human users. Rather, ELAI embodies a universal cryptographic trust verification protocol applicable to any two entities capable of holding and presenting a cryptographic hash value.

The core insight is that the verification process disclosed in the parent application-two entities each independently presenting a cryptographic hash to a neutral verification layer, which resolves to a binary trust state-constitutes a general-purpose protocol that operates independently of:
Entity type (persons, devices, organizations, autonomous systems, etc.);
Transport medium (BLE, NFC, network protocols, optical, acoustic, future technologies);
Application context (sharing economy, machine-to-machine communication, institutional trust, etc.); and
Temporal constraints (implementable across multiple decades and technology generations).

This continuation-in-part application therefore discloses the universal ELAI protocol, generalizing the parent application's implementation to all entity-to-entity trust verification scenarios.

Existing trust and authentication systems suffer from several fundamental limitations, as follows:
Identity issued by authority: Traditional systems (PKI, certificate authorities, single sign-on providers) rely on a trusted third party to issue credentials. If the authority is compromised, all issued identities are suspect. The credential is separate from the entity it represents;
Persistent trust state: Reputation systems, trust graphs, and session-based authentication accumulate trust over time or maintain session state. Once trust is established, it persists until explicitly revoked. This creates security vulnerabilities when context changes or credentials are stolen;
Centralized evaluation: Systems like OAuth, SAML, and enterprise identity providers require a central server to evaluate and grant trust. If the server is unavailable or compromised, verification fails or becomes unreliable;
Platform-mediated verification: Existing trust systems are typically embedded within a specific platform or service (e.g., login providers, payment gateways). Entities cannot verify trust directly; they must rely on the platform as an intermediary;
Transport-specific protocols: Security protocols like TLS, IPsec, and Bluetooth pairing are tied to specific transport layers. A new transport technology requires a new security protocol, and credentials often cannot migrate between technologies;
Limited scope: Most verification systems are designed for person-to-person or person-to-service interactions. There is no general-purpose protocol for arbitrary entity-to-entity trust that scales to devices, autonomous systems, organizations, and future entity types; and
Reusable credentials: Session tokens, bearer tokens, and authentication cookies are designed to be reusable across multiple transactions. This creates attack vectors for credential theft and replay attacks.

There is a need in the art for a cryptographic trust verification protocol that:
Derives identity from the entity itself, not from an external authority;
Treats each verification event as independent, defaulting to zero trust regardless of history;
Operates without centralized infrastructure, enabling direct entity-to-entity verification;
Functions identically across all current and future transport technologies;
Applies to any entity type capable of holding a cryptographic hash;
Produces non-reusable, event-bound verification results to prevent credential reuse attacks; and
Provides an auditable chain of verification events without maintaining persistent trust state.

The present invention addresses these needs by disclosing the ELAI universal cryptographic trust verification protocol.

### BRIEF DESCRIPTION OF THE INVENTION

The present invention provides a method and system for cryptographic trust verification between entities. Each entity possesses a cryptographic hash value derived from and inseparable from the entity's own identity. A verification membrane comprising an Encrypted Layered Authentication Intelligence (ELAI) layer is positioned between any two entities during a verification event. The verification membrane is a neutral positional space that belongs to neither entity.

During a verification event, each entity independently presents its cryptographic hash value to the verification membrane. The membrane records receipt of each hash as an independent event. The membrane resolves the verification event to a verified state when both hashes have been received for the same event, and to an unverified state otherwise.

Verification is event-specific, temporally bound, and non-persistent. Each subsequent verification event between any entities begins from a default unverified state, regardless of any prior verification history. No accumulation of prior verified states alters the default state of future events.

The protocol is transport-agnostic, operating identically across radio frequency communication, near-field communication, Bluetooth, optical signaling, acoustic signaling, network packet transport, direct electrical contact, and future communication media, without modification of verification logic.

The protocol is entity-agnostic, applying to any combination of natural persons, electronic devices, autonomous systems, organizations, artificial intelligence agents, vehicles, structures, biological constructs, and future constructs capable of holding and presenting a cryptographic hash value.

Each verification event generates an immutable attestation record comprising the two entity hash values, the binary result (verified or unverified), and a temporal marker. Attestation records form an auditable chain of verification events.

In certain embodiments, the verification membrane performs hash resolution using a multi-layer, counter-shifting cryptographic cipher comprising a plurality of symbol channels and a prime-indexed disruptor channel, the cipher being configured to collapse an indeterminate trust state between entities into a definite binary verification result.

The invention extends the ELAI implementation disclosed in the parent application (peer-to-peer sharing platform) to define the universal protocol applicable to all entity-to-entity trust verification scenarios across all contexts, transports, and time periods.

### BRIEF DESCRIPTION OF THE DRAWINGS

FIG. 1 is a block diagram illustrating the universal ELAI protocol architecture, showing two entities and a verification membrane positioned between them.

FIG. 2 is a flowchart depicting the method steps of a verification event according to the present invention.

FIG. 3 is a diagram showing the event-specific, non-persistent trust model, illustrating multiple verification events over time.

FIG. 4 is a table showing exemplary entity types, transport media, and verification contexts across multiple implementation eras (2020-2150+).

FIG. 5 is a block diagram of the multi-layer counter-shifting cryptographic cipher used for hash resolution in certain embodiments.

FIG. 6 is a diagram illustrating physical proximity verification using mobile devices, corresponding to the parent application implementation.

FIG. 7 is a diagram illustrating machine-to-machine verification between autonomous systems.

FIG. 8 is a diagram illustrating organization-to-organization institutional trust verification.

### DETAILED DESCRIPTION

The present invention discloses a universal cryptographic trust verification protocol referred to as Encrypted Layered Authentication Intelligence, or “ELAI.” The protocol is expressed in its most reduced form by the following canonical notation:

$${entity}_{1} < hash > - ELAI - < hash > {entity}_{2} = \{ 0 , 1 \}$$

Where:
entity₁, entity₂ represent any two entities capable of holding and presenting a cryptographic hash value:
<hash>represents the cryptographic hash value possessed by each entity;
   ELAI represents the verification membrane positioned between the entities; and
   {0, 1} represents the binary verification result: 0 (unverified) or 1 (verified).

This notation is not merely a conceptual diagram; it is the formal expression of the protocol. The protocol invariant is that two entities present their hashes to ELAI, and ELAI resolves to 0 or 1. This operation is identical regardless of entity type, transport medium, application context, or time period.

Here are the terms and definitions as used here:
Entity: Any construct capable of holding and presenting a cryptographic hash value. Entities include but are not limited to natural persons, electronic devices (smartphones, tablets, computers, IoT devices), vehicles, structures (buildings, facilities), organizations (corporations, governments, institutions), autonomous systems (robots, drones, automated agents), artificial intelligence agents, biological constructs, and any future construct capable of the same function. The parent application demonstrates entities of type “natural person” and “mobile device”; the present application generalizes to all entity types;
Cryptographic Hash (or Hash): A cryptographic identity value deterministically derived from the entity itself at the moment of identity creation. The hash is not a token, credential, or identifier issued by an external authority. It is a mathematical proof of existence, inseparable from the entity it represents. It is the bilateral simultaneous presentation of the hash to a neutral third-party-free membrane that distinguishes its use. In preferred embodiments, the hash is seeded through a multi-layer encryption pipeline, such as the counter-shifting cipher described below. The hash persists across all transport layers and is unique to the entity;
ELAI (Encrypted Layered Authentication Intelligence): The verification membrane positioned between any two entities during a trust verification event. ELAI is not a service, server, application, or endpoint. ELAI is a neutral positional space—the logical “location” where two hashes meet and resolve. ELAI belongs to neither entity, serves neither entity's interest, and exists only at the point of interaction between entities. In certain embodiments, ELAI employs a multi-layer counter-shifting cryptographic cipher as its resolution mechanism;
Verification Event: A single, atomic interaction in which two entities each independently present their cryptographic hash to ELAI for resolution. Each event is independent, temporally bound, and non-persistent. The default state of any verification event is 0 (unverified). Resolution to 1 (verified) occurs only when both entities' hashes are received by ELAI for the same event within a defined temporal window;
Default State (0): Every verification event begins in the unverified state (0). This is not a failure state—it is the natural condition of indeterminacy between any two entities prior to mutual hash presentation. No prior history, reputation score, relationship data, or external information modifies the default state. Each event is evaluated independently from the default;
Transport Layer: The communication medium through which cryptographic hashes are presented to ELAI. The protocol is transport-agnostic, meaning the verification logic and result are identical regardless of whether hashes are transmitted via radio frequency, NFC, BLE, QR code (optical), acoustic signal, network packet (TCP/IP, UDP, etc.), direct electrical contact, or any future medium. The parent application demonstrates specific transports (BLE, NFC, GPS-based network communication); the present application claims transport invariance;
Attestation Record: An immutable record generated upon resolution of a verification event. The attestation record comprises: (i) the first entity's cryptographic hash, (ii) the second entity's cryptographic hash, (iii) the binary result (0 or 1), and (iv) a temporal marker (timestamp). Attestation records may be stored locally by one or both entities, or in a shared ledger. Attestations are not editable, reversible, or transferable. Multiple attestations between the same two entities form a verification history, but each attestation is independently generated per event; and
Non-Persistent Verification: The property that each verification event's result does not carry forward to subsequent events. A verified state (1) in event N does not influence the default state (0) of event N+1. This ensures that trust must be actively re-established for each interaction, preventing stale or inherited trust from propagating across contexts.

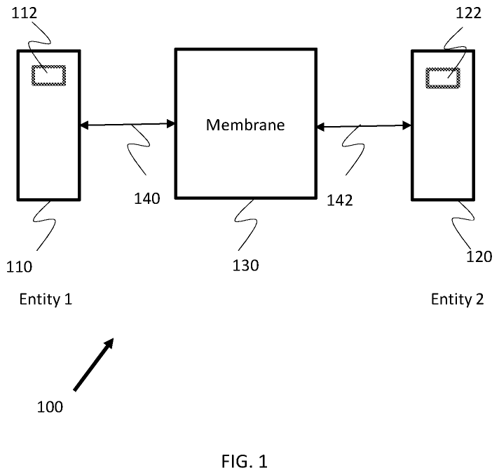

Referring to FIG. 1, the universal ELAI protocol architecture 100 comprises a first entity 110, a second entity 120, and a verification membrane 130 (ELAI) positioned logically between them.

First Entity (110): Possesses a first cryptographic hash 112 derived from the identity of the first entity. The first entity 110 may be any of the entity types defined above. In the context of the parent application, the first entity is a natural person using a mobile device (driver or passenger). In generalized embodiments, the first entity may be a device, autonomous system, organization, or other construct.

Second Entity (120): Possesses a second cryptographic hash 122 derived from the identity of the second entity. The second entity 120 is independent of the first entity 110 and may be of the same or different entity type.

Verification Membrane (130): Comprises the ELAI verification layer. The membrane 130 receives hash presentations from entities and resolves verification events. In certain embodiments, the membrane 130 is implemented as executable logic on a backend server (as in the parent application's ride-sharing platform). In other embodiments, the membrane 130 is implemented as distributed logic instantiated at the point of interaction between entities (e.g., peer-to-peer protocol without server). In all embodiments, the membrane 130 is logically positioned “between” the entities—it is the neutral space where hashes meet. The verification membrane is not merely a mathematical function but a structurally defined neutral execution environment.

Communication Channels (140, 142): Represent the transport media by which entities present hashes to the verification membrane. Channels 140 and 142 may use any transport technology. In the parent application, channels comprise network connections over the Internet and cellular data networks, as well as proximity-based channels (BLE, NFC). In generalized embodiments, channels may use radio frequency, optical, acoustic, or future transport technologies. The protocol logic within the verification membrane 130 is invariant across all channel types.

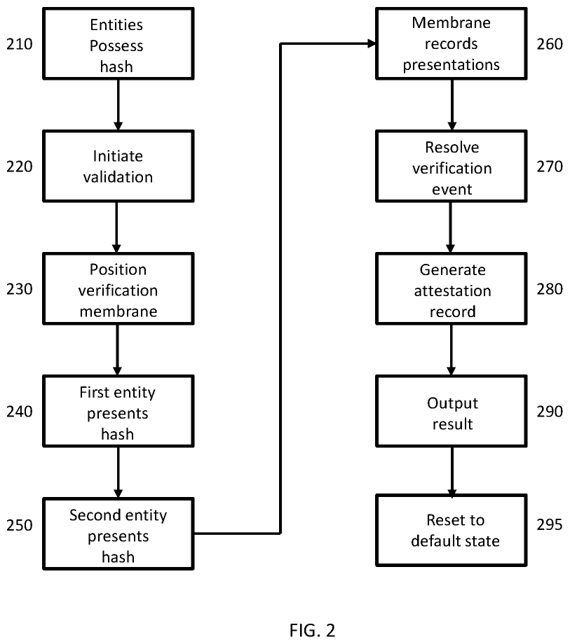

Referring to FIG. 2, a method 200 for cryptographic trust verification between entities proceeds as follows:
Step 210: Entities Possess Hashes. A first entity possesses a first cryptographic hash derived from the first entity's identity. A second entity possesses a second cryptographic hash derived from the second entity's identity. Hash derivation is described below;
Step 220: Initiate Verification Event. A verification event is initiated when the first entity and second entity seek to establish trust. The event may be initiated by user action (e.g., driver selecting passenger in parent application), device proximity (e.g., two IoT devices detecting co-location), system trigger (e.g., autonomous systems initiating interaction), or any other mechanism appropriate to the entity types and context;
Step 230: Position Verification Membrane. The verification membrane (ELAI) is instantiated or invoked between the entities. In server-based embodiments (parent application), the membrane is a verification module on the backend server. In peer-to-peer embodiments, the membrane is protocol logic executed on one or both devices or on a shared edge node;
Step 240: First Entity Presents Hash. The first entity independently presents its cryptographic hash to the verification membrane via an available transport channel. The presentation is an independent action; it does not depend on or wait for the second entity;
Step 250: Second Entity Presents Hash. The second entity independently presents its cryptographic hash to the verification membrane via an available transport channel. This presentation is also independent;
Step 260: Membrane Records Presentations. The verification membrane records receipt of each hash as an independent event record. The membrane maintains state indicating which hashes have been received for the current verification event;
Step 270: Resolve Verification Event. The membrane evaluates whether both hashes have been received. If both the first hash and the second hash are present, the membrane resolves the event to verified (1). If one or both hashes are missing, or if hashes were presented outside the temporal window of the event, the membrane resolves to unverified (0);
Step 280: Generate Attestation Record. Upon resolution, the membrane generates an immutable attestation record comprising: the first hash, the second hash, the binary result (0 or 1), and a timestamp. The attestation is stored and/or transmitted to the entities;
Step 290: Output Result. The verification result is output to one or both entities. In the parent application, the result is transmitted to the driver and passenger devices to indicate successful match. In other embodiments, the result may trigger automated actions (e.g., unlock door, authorize transaction, initiate data exchange); and
Step 295: Reset to Default State. Following resolution, the verification event is closed. Any subsequent interaction between the same or different entities initiates a new verification event starting from the default unverified state (0). No persistent trust state carries forward.

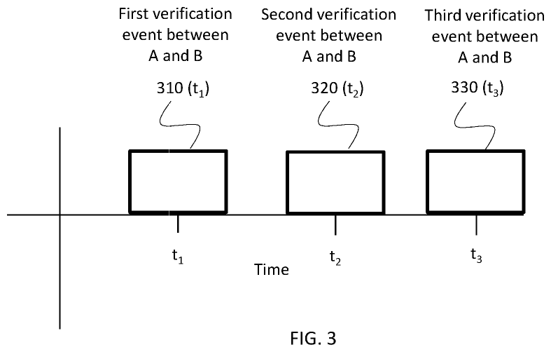

Referring to FIG. 3, the event-specific, non-persistent trust model is illustrated. A timeline 300 shows multiple verification events 310, 320, 330 between entities over time.

Event 310 (t₁): First verification event between Entity A and Entity B. Both present hashes; membrane resolves to verified (1). Attestation record generated.

Event 320 (t₂): Second verification event between Entity A and Entity B. Despite prior verified state in Event 310, Event 320 begins from default state (0). Both entities must independently present hashes again. Event resolves to verified (1). New attestation record generated.

Event 330 (t₃): Third verification event between Entity A and Entity C (different entity). Event 330 is entirely independent of Events 310 and 320. Begins from default state (0). Entity A and Entity C present hashes; resolves to verified (1).

Key Principle: Each event is independent. The result of Event 310 does not influence the default state of Event 320, even though the same entities are involved. There is no “session” or “logged-in state” that persists across events. Trust must be actively re-established for each interaction.

Verification History: The sequence of attestation records (310, 320, 330, . . . ) forms a verification history. The history is auditable and provides a record of past trust events. However, the history is read-only; past events do not alter the default state of future events. An entity with 1,000 prior verified events still presents its hash from a default unverified state for event 1,001.

This model provides several security advantages:
No credential reuse attacks: A stolen or intercepted hash presentation for Event 310 cannot be replayed for Event 320, because each event requires fresh hash presentation;
No persistent compromise: If an entity's hash is temporarily compromised during one event, the compromise does not propagate to subsequent events (assuming the entity detects and rotates its hash); and
Temporal isolation: Each event is bound to a specific time window. Late or early hash presentations do not resolve.

Cryptographic hash values are deterministically derived from entity identity data. In preferred embodiments, hash derivation uses a multi-layer counter-shifting cryptographic cipher, as disclosed in the parent application and described here in generalized form.

Step 1: Identity Data Input. Raw identity data associated with an entity is collected. For a natural person (parent application context), identity data may include name, email, phone number, biometric data, or other identifying information. For a device, identity data may include hardware identifiers (MAC address, serial number, device UUID). For an organization, identity data may include legal name, jurisdiction, registration number. For an autonomous system, identity data may include system identifier, firmware hash, or configuration fingerprint.

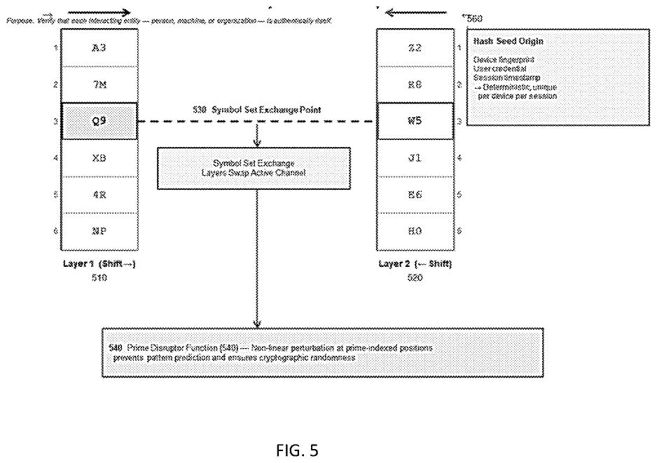

Step 2: Multi-Layer Cipher Processing. The identity data is processed through a multi-layer counter-shifting cryptographic cipher. Referring to FIG. 5, the cipher 500 comprises:
Symbol Channels (510): A plurality of vertical channels, each holding a sequence of symbols. In a preferred embodiment, seven symbol channels are used. Symbols may be alphanumeric characters, binary digits, or other discrete values;
Counter-Shifting Layers (520): Four horizontal layers that shift symbol position in alternating directions. Layer 1 shifts right; Layer 2 shifts left; Layer 3 shifts right; Layer 4 shifts left. Shifting advances symbols through the channels; and
Prime Disruptor Column (530): A designated column (e.g., the third or fifth column) indexed by prime numbers. The disruptor column introduces non-linear perturbations to symbol sequences, increasing entropy and preventing pattern prediction.

Identity data is fed into the cipher 500 as an input sequence. The cipher processes the sequence through the counter-shifting layers, with the prime disruptor column introducing controlled chaos. After a predetermined number of shifts (e.g., 256 or 512 cycles), the cipher outputs an intermediate symbol sequence.

Step 3: Compression to Hash Value. The intermediate symbol sequence is compressed into a fixed-length cryptographic hash value. Compression may use standard cryptographic hash functions (SHA-256, SHA-3, BLAKE2) or proprietary compression algorithms. The resulting hash is a compact, deterministic representation of the entity's identity.

Step 4: Storage and Presentation. The hash is stored with the entity (e.g., on a mobile device, in device firmware, in organizational records). The entity presents this hash during verification events. The hash is inseparable from the entity in the sense that it is mathematically derived from the entity's unique identity data; it is not a token issued by an external party.

Hash Uniqueness and Collision Resistance: The multi-layer cipher and cryptographic compression ensure that each entity's hash is unique with extremely high probability. Hash collisions are computationally infeasible.

Hash Rotation (Optional): In certain embodiments, entities may periodically rotate their hash by re-running the derivation process with updated identity data or a new seed value. Rotation enhances security by limiting the window of exposure if a hash is compromised.

The ELAI protocol is transport-agnostic. The verification logic—entities present hashes, membrane resolves to 0 or 1—is identical regardless of the transport medium used to convey hashes.

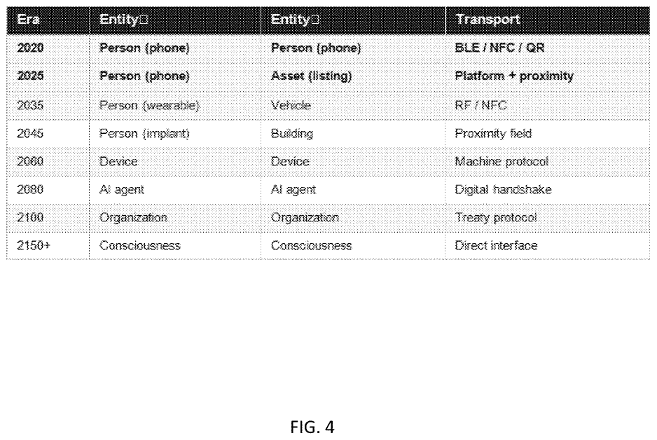

Referring to FIG. 4, a table 400 shows exemplary entity types, transport media, and verification contexts across multiple implementation eras:
Era 2020 (Parent Application):
   Entity Types: Natural person (driver), natural person (passenger);
   Devices: Smartphone, smartphone;
   Transport: BLE, NFC, QR code, cellular/Internet; and
   Context: Ride-sharing platform.
Era 2025 comprises:
   Entity Types: Natural person, physical asset (vehicle);
   Devices: Smartphone, IoT-enabled vehicle;
   Transport: BLE, NFC, network; and
   Context: Asset custody transfer (rental car, bike share).
Era 2035 comprises:
   Entity Types: Natural person, autonomous vehicle;
   Devices: Wearable device, vehicle AI system;
   Transport: RF, NFC, 6G network; and
   Context: Autonomous taxi service.
Era 2045 comprises:
   Entity Types: Natural person, smart building;
   Devices: Biometric implant, building access system;
   Transport: Proximity field (next-gen NFC), optical (iris scan); and
   Context: Building access control.
Era 2060 comprises:
   Entity Types: Autonomous device, autonomous device;
   Devices: IoT sensor, IoT actuator;
   Transport: Machine protocol (e.g., MQTT over low-power RF); and
   Context: Industrial automation.
Era 2080 comprises:
   Entity Types: AI agent, AI agent;
   Devices: Distributed AI nodes;
   Transport: Quantum-secured network, optical; and
   Context: Inter-AI negotiation and collaboration.
Era 2100 comprises:
   Entity Types: Organization, organization;
   Devices: Institutional verification systems;
   Transport: Interplanetary network, laser communication; and
   Context: Treaty and contract verification between space-faring entities.
Era 2150+ comprises:
   Entity Types: (Future entity type), (future entity type);
   Devices: (Future device/interface);
   Transport: (Future communication medium); and
   Context: (Future application).

In every era, the protocol is identical: entity₁<hash>—ELAI—<hash>entity₂={0, 1}.

The transport changes, the entity types evolve, the devices are replaced, but the verification logic remains invariant.

To implement ELAI on a new transport medium, only the transport-layer interface needs to be adapted. The entities encode their hashes into the format appropriate for the transport (e.g., BLE advertisement packet, NFC NDEF message, optical QR code, acoustic frequency modulation, network API call). The verification membrane decodes the received hashes from the transport format and applies the identical resolution logic. No modification to the protocol core is required.

The parent application U.S. Ser. No. 17/085,257 discloses a specific implementation of ELAI within a ride-sharing and sharing-economy platform. This implementation serves as the first instantiation of the universal protocol disclosed herein. Key elements of the parent implementation that support the present claims include:

Peer-to-Peer Verification wherein:
The parent application describes a ride-sharing transaction in which a driver and passenger each use a mobile device to interact with a backend server. The server receives driver input data (including driver destination) and passenger input data (including passenger destination). The server determines that the driver and passenger satisfy predetermined matching criteria based on route proximity and destination correspondence. Upon match, the server transmits rideshare data to the driver device, the driver selects the passenger, the server sends a ride proposal to the passenger, and the passenger accepts.
This flow is an implementation of the universal ELAI protocol: the driver entity and passenger entity each present credentials (their input data, derived from their identity) to the verification membrane (backend server), which resolves the match to a binary result (match found=1, no match=0) and outputs the result to the entities (ride proposal and acceptance). The present CIP generalizes this peer-to-peer verification to all entity types and contexts.
   Hash-Based Identity wherein:
The parent application discloses that users are assigned cryptographic hashes derived from their identity. The specification describes a multi-layer encryption process that generates a unique hash for each user. This hash is stored on the user's mobile device and presented to the platform during interactions.

The present CIP generalizes this to: any entity possesses a cryptographic hash derived from and inseparable from the entity's identity, applicable to persons, devices, organizations, and all other entity types.

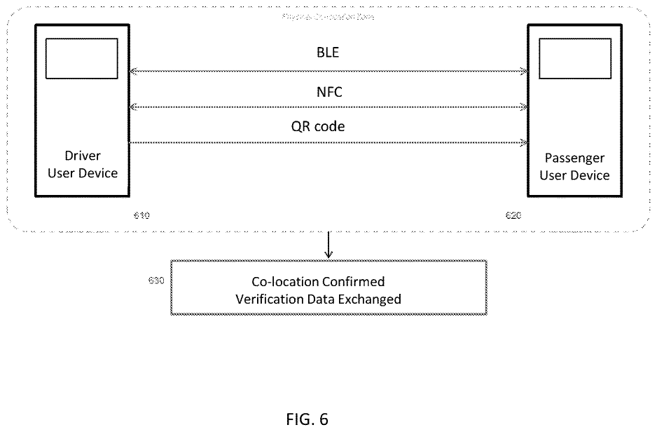

Referring to FIG. 6 (adapted from parent application disclosure), the parent describes proximity-based verification using BLE, NFC, and QR codes. When a driver and passenger are physically co-located, their mobile devices exchange verification data via short-range communication. The system confirms co-location as a factor in trust verification.

The present CIP generalizes this as: hash presentation occurs through any available transport, including proximity-based transports (BLE, NFC, optical code exchange), and co-presence may be a precondition for hash presentation. The protocol applies to any two entities in proximity, not just driver and passenger.

The parent application describes a model in which users must verify their identity and intent for each transaction. There is no persistent “logged in” state that grants ongoing access. Each ride proposal is independently evaluated; prior ride history does not automatically authorize future rides.

The present CIP formalizes this as the event-specific, non-persistent trust model: each verification event defaults to unverified (0), and past verified states do not alter future default states.

The parent application describes scenarios in which a user takes custody of a shared asset (vehicle, bike, equipment). Custody transfer is recorded and verified by the platform.

The present CIP generalizes this as: verification between a person-entity and an asset-entity, where the asset possesses an asset-specific hash. Verified state authorizes custody transfer, recorded as an attestation event. This applies to any physical asset with an associated hash (vehicles, equipment, inventory items, etc.).

The parent application describes a multi-layer encryption process used to generate user credentials. While the parent does not explicitly describe the counter-shifting cipher in the same generalized terms as the present application, the underlying cryptographic pipeline is disclosed.

The present CIP extends this disclosure to define the counter-shifting cipher architecture (symbol channels, prime disruptor column) as the mechanism by which ELAI resolves the indeterminate trust state between entities into a definite binary result.

The parent application's backend server performs the role of the verification membrane. The server receives input from both entities (driver and passenger), applies matching logic (predetermined criteria), and outputs the result (rideshare data, ride proposal, acceptance confirmation).

The present CIP generalizes this architecture: one or more servers comprise the verification membrane, receiving hashes from entities, resolving to binary result, and outputting attestation. The CIP further extends to serverless (peer-to-peer) implementations where the membrane is distributed logic at the point of interaction.

The following aspects of the present invention constitute new matter not explicitly disclosed in the parent application, and therefore receive the filing date of the present CIP:

### Entity-Agnostic Scope:

The parent application describes verification between natural persons (driver and passenger) using mobile devices within a sharing-economy platform. The present CIP extends “entity” to include: electronic devices (as independent entities, not merely user interfaces), vehicles, structures, organizations, autonomous systems, AI agents, biological constructs, and any future construct capable of holding a cryptographic hash. This generalization is new matter.

### Transport-Agnostic Protocol:

The parent application discloses specific transports: BLE, NFC, QR codes (optical), GPS-based location tracking, and Internet/cellular network communication. The present CIP claims that the protocol is transport-agnostic—the verification logic is invariant across all transports, including radio frequency, optical, acoustic, direct electrical, quantum-secured networks, and future media. The explicit claim of transport invariance is new matter.

### Canonical Notation and ELAI as Positional Membrane:

The expression entity₁<hash>—ELAI—<hash>entity₂={0, 1} and the conceptualization of ELAI as a neutral positional membrane (rather than a software module or server) are new formalizations introduced in the present CIP. The parent describes ELAI as a verification “layer” or “system,” but does not explicitly describe it as a neutral positional space belonging to neither entity. This reframing is new matter.

### Temporal Unboundedness and Cross-Generational Implementation:

The parent application is implicitly time-bound to the technology available circa 2020 (smartphones, BLE, cellular networks). The present CIP explicitly claims that the protocol is invariant across multiple decades and technology generations, as illustrated in the temporal scope table (FIG. 4). The claim that cryptographic hashes created under an earlier transport technology remain valid and verifiable under later transport technologies without re-issuance is new matter.

### Explicit Event-Independence and Non-Accumulation:

While the parent application describes per-transaction verification, it does not explicitly articulate the principle that each event is independent and that no accumulation of prior verifications alters the default state of future events. The present CIP formalizes this as a core protocol property: non-persistent verification, with each event evaluated independently from default state (0). This formalization is new matter.

### Machine-to-Machine and Organization-to-Organization Verification:

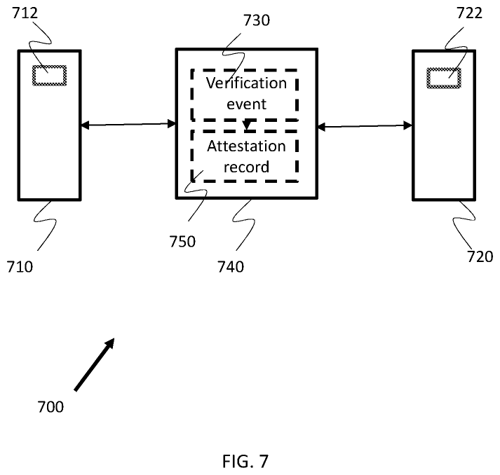

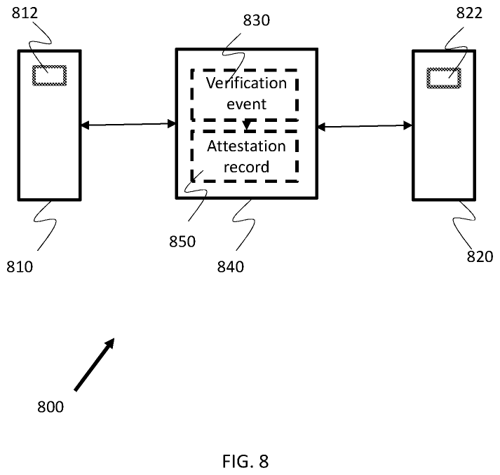

The parent application contemplates person-to-person and person-to-platform interactions. The present CIP explicitly extends to autonomous system-to-system verification (FIG. 7) and organization-to-organization institutional trust (FIG. 8), scenarios not described in the parent. These use cases are new matter.

Referring to FIG. 7, an exemplary embodiment of machine-to-machine verification 700 is illustrated. A first autonomous system 710 (e.g., industrial robot, autonomous vehicle, IoT sensor) possesses a first cryptographic hash 712. A second autonomous system 720 (e.g., another robot, drone, edge computing node) possesses a second cryptographic hash 722.

The systems 710 and 720 initiate a verification event 730 without human intervention. For example, two industrial robots may need to coordinate on a shared task; two autonomous vehicles may need to negotiate right-of-way; two IoT devices may need to exchange sensor data.

Each system independently presents its hash to the verification membrane 740 (which may be a shared edge server, a peer-to-peer protocol between the devices, or a distributed ledger node). The membrane resolves the event to verified (1) or unverified (0). If verified, the systems proceed with their coordinated action. If unverified, the action is blocked.

Attestation and Audit: Each machine-to-machine verification event generates an attestation record 750. Over time, the systems build a verification history. The history may be used for audit, compliance, and forensic analysis (e.g., determining which systems interacted and when), but does not create persistent trust. Each new interaction requires fresh hash presentation.

No Human Initiation: The key distinction from the parent application is that machine-to-machine verification occurs autonomously. No human user selects or approves the interaction. The protocol enables machines to establish cryptographic trust directly, a requirement for autonomous systems operating at scale.

Referring to FIG. 8, an exemplary embodiment of organization-to-organization verification 800 is illustrated. A first organization 810 (e.g., Corporation A, Government Agency X, University Y) possesses an organizational cryptographic hash 812 derived from the organization's legal identity (name, jurisdiction, registration documents, public key, etc.). A second organization 820 (e.g., Corporation B, Partner Entity Z) possesses a second organizational hash 822.

The organizations enter into a bilateral agreement (treaty, contract, memorandum of understanding, data-sharing agreement, etc.). To cryptographically bind the agreement, each organization presents its hash to the verification membrane 830. The membrane resolves to verified (1), and an attestation record 840 is generated. The attestation serves as a cryptographically signed, timestamped record of the agreement event.

Equivalence to Legal Instruments: The verified state in an organization-to-organization context is functionally equivalent to the execution of a legal contract. The attestation record 840 provides proof that both organizations independently affirmed the agreement at a specific time. The record is immutable and auditable.

Multi-Party Extensions: While the canonical protocol is bilateral (two entities), extensions to multi-party verification are possible. For example, three organizations may each present hashes to a shared verification membrane, and the membrane resolves to verified only when all three hashes are received. This enables cryptographically bound multi-party agreements.

Cross-Jurisdictional Trust: Organization-to-organization verification operates across legal jurisdictions. An organization in Country A and an organization in Country B can verify trust using ELAI without reliance on a trusted third party (notary, escrow agent, international authority). The protocol itself provides the neutral ground for trust establishment.

Each verification event generates an attestation record. The attestation comprises:
First Entity Hash: The cryptographic hash of the first entity;
Second Entity Hash: The cryptographic hash of the second entity;
Binary Result: 0 (unverified) or 1 (verified);
Timestamp: A temporal marker indicating when the event was resolved; and
Optional Metadata: Event identifier, context descriptor, transport type, location data, and so on.

Attestation records are immutable. Once generated, they cannot be edited, reversed, or deleted (in trusted implementations). Attestations may be stored:
Locally by entities: Each entity retains a copy of attestations in which it participated;
On backend server: In platform-based implementations (parent application), the server retains attestations as transaction records; and
On distributed ledger: In blockchain or distributed ledger implementations, attestations are written as ledger entries, providing tamper-evident audit trail.

Verification History: The sequence of attestations between two entities forms a verification history. For example, if Entity A and Entity B interact 100 times over a year, there are 100 attestation records. The history provides:
Audit trail: Proof of when and how often entities interacted;
Reputation signal: While not used to alter default state, history may inform entity decisions (e.g., Entity A may choose to interact with Entity B based on their positive history);
Forensic analysis: In case of dispute or security incident, the history shows the sequence of verified events; and
Non-Persistent Nature: Despite the existence of verification history, each new event still defaults to unverified (0). History is informational, not authorizing. This prevents “trust debt” from accumulating and ensures that each event is independently secure.

While the parent application describes a back-end-server architecture, the universal ELAI protocol supports decentralized and server-less implementations.

Peer-to-Peer Protocol: In a peer-to-peer embodiment, two entities communicate directly without a central server. The verification membrane is protocol logic executed on one or both devices. For example:
Device A and Device B establish a communication channel (e.g., BLE connection, local Wi-Fi Direct, NFC);
Device A sends its hash to Device B;
Device B sends its hash to Device A;
Each device runs the ELAI resolution logic locally: both hashes received→verified (1); otherwise unverified (0); and
Each device generates a local attestation record and optionally exchanges attestations for mutual confirmation.

Edge and Fog Computing: In Internet of Things (IoT) and edge computing scenarios, the verification membrane may be instantiated on an edge node (local gateway, fog server) rather than a remote cloud server. Entities present hashes to the edge node, which resolves and returns results with low latency. Edge-based ELAI reduces reliance on Internet connectivity and central infrastructure.

Blockchain and Distributed Ledger: In blockchain-based embodiments, the verification membrane is a smart contract or consensus protocol. Entities submit hash presentations as transactions to the blockchain. The smart contract evaluates whether both hashes are present and writes the attestation to the ledger. This provides tamper-evident, decentralized verification without a trusted central party.

The ELAI protocol provides several security properties:

### Tamper-Evident Verification:

Because the binary result depends on both entities' hashes being received, interception or modification of either hash causes resolution to fail (unverified). An attacker who intercepts Entity A's hash and attempts to substitute a fake hash will cause the membrane to resolve to 0, because the fake hash does not match the expected hash of Entity A.

### Replay Attack Resistance:

Each verification event is temporally bound. A hash presentation for Event N cannot be reused for Event N+1. Even if an attacker captures Entity A's hash during Event N, replaying it in Event N+1 is detected because Event N+1 expects a fresh hash presentation within the new event's temporal window. The non-persistent nature of verification prevents replay attacks.

### No Single Point of Failure:

In decentralized implementations, there is no single server or authority whose compromise breaks the entire system. Each entity holds its own hash, and the verification membrane can be distributed across multiple nodes, edge devices, or peer-to-peer channels.

### Cryptographic Binding:

The attestation record cryptographically binds the two entities to the verified event. Because the attestation includes both hashes and a timestamp, it provides proof that both entities were present and verified at that specific time. The attestation can be independently verified by third parties (e.g., auditors, courts) by checking the hashes and timestamp.

Forward Secrecy (with Hash Rotation):

If entities periodically rotate their hashes (re-derive using updated identity data or new seed), forward secrecy is achieved. Even if an attacker compromises an entity's hash at time T, all verification events prior to T remain secure (the old hash was valid then), and all events after T use a new hash (the compromised hash is no longer valid).

Here is an example of a driver and passenger each using the ride-share mobile app invention of the parent application. The driver enters a destination; the passenger enters a destination. The backend server (ELAI membrane) receives both inputs, determines that the routes match, and sends a ride proposal to both parties. Both must independently accept (present their hashes via acceptance action). Upon acceptance, the server generates an attestation confirming the verified ride. The driver picks up the passenger, and the ride proceeds. At the end of the ride, both parties confirm completion (new verification event), generating a second attestation.

In another example a person with a biometric implant approaches a smart building. The building's access system detects the person's proximity and requests hash presentation. The person's implant transmits the person's cryptographic hash via NFC. The building's access system presents the building's hash (derived from the building's identity: address, owner, access policy). The verification membrane (edge server at building entrance) receives both hashes, resolves to verified, and generates an attestation. The building unlocks the door. Each entry is a separate verification event; prior entries do not grant automatic future access.

In a third example, two autonomous vehicles approach an intersection. Each vehicle possesses a cryptographic hash (derived from vehicle ID, firmware, owner identity). The vehicles communicate via vehicle-to-vehicle (V2V) radio. Each vehicle presents its hash to the other. The verification membrane (distributed protocol running on both vehicles) resolves to verified, confirming both vehicles are authenticated and authorized. The vehicles then negotiate right-of-way based on traffic rules, with the verified state ensuring neither vehicle is a spoofed or rogue actor.

In a fourth example, University A and Pharmaceutical Company B enter into a research data-sharing agreement. Each organization possesses an organizational hash. Representatives of each organization use institutional verification systems to present their organization's hash to a shared verification membrane (blockchain smart contract). The membrane resolves to verified and generates an attestation record on the blockchain. The attestation serves as cryptographic proof of the agreement. Data sharing proceeds under the terms of the agreement, with each data transfer event optionally generating a new attestation (per-event verification of ongoing compliance).

In a fifth example, a user purchases a new IoT sensor (smart thermostat). The user's smartphone (possessing the user's hash) and the thermostat (possessing a device hash) need to pair. The user initiates pairing via the smartphone app. The smartphone and thermostat exchange hashes via BLE. The verification membrane (pairing protocol running on both devices) resolves to verified. An attestation is generated and stored on both devices. The thermostat is now paired to the user and will only accept commands from devices that can present the user's hash in future verification events.

The universal ELAI protocol provides advantages over prior art trust and authentication systems as follows:
Identity derived from entity, not authority: No reliance on certificate authorities, identity providers, or trusted third parties to issue credentials;
Event-specific, non-persistent trust: Each verification event is independent, preventing stale trust, credential reuse, and session hijacking;
Transport-agnostic: Identical verification logic across all transport media, enabling seamless migration to new technologies;
Entity-agnostic: Applicable to persons, devices, organizations, autonomous systems, and future entity types without protocol modification;
Decentralizable: Can operate without central infrastructure, supporting peer-to-peer, edge, and blockchain implementations;
Tamper-evident and auditable: Attestation records provide cryptographic proof of verification events, supporting compliance and forensics; and
Scalable to future technologies: The protocol invariant (entity₁<hash>—ELAI—<hash>entity₂) is timeless, enabling implementation across multiple technology generations.

While the preferred embodiment uses a multi-layer counter-shifting cipher, other cryptographic hash algorithms may be used (SHA-256, SHA-3, BLAKE2, Argon2, etc.). The core protocol (two hashes presented to membrane, binary resolution) is independent of the specific hash algorithm.

The protocol can be extended to more than two entities. For example, a three-entity verification requires all three hashes to be presented to the membrane before resolving to verified. This enables multi-party contracts, group access control, and collaborative workflows.

The membrane's resolution logic can incorporate additional conditions beyond simple hash presence. For example, in the parent application, route proximity and destination correspondence are evaluated. In generalized embodiments, conditions may include time-of-day constraints, location-based policies, role-based access control, or cryptographic challenges.

In certain embodiments, entities present hashed or encrypted versions of their hashes (e.g., using zero-knowledge proofs or homomorphic encryption) to prevent the membrane from learning the actual hash values while still enabling verification. This enhances privacy in scenarios where the membrane is not fully trusted.

In scenarios where network connectivity is unavailable, entities may exchange signed attestations from prior events (stored locally) as proof of past verification. While not a real-time verification event, offline attestation exchange provides a trust signal in disconnected environments.

The invention may be implemented in software (executable instructions on processors), hardware (dedicated cryptographic processors, FPGAs), firmware (embedded systems), or combinations thereof. The verification membrane may be a cloud server, edge device, mobile application, smart contract, or embedded system.

Implementation may use any programming language (C, C++, Java, Python, Rust, Solidity, etc.) and any platform (IOS, Android, Linux, embedded RTOS, blockchain VM, etc.). The protocol logic is platform-independent.

The universal ELAI protocol is suitable for standardization (e.g., IEEE, IETF, ISO standards). Standardization would enable interoperability between implementations from different vendors, ensuring that Entity A using Vendor X's ELAI implementation can verify trust with Entity B using Vendor Y's implementation.

The present invention discloses a universal cryptographic trust verification protocol, Encrypted Layered Authentication Intelligence (ELAI), that establishes trust between any two entities through independent presentation of cryptographic hash values to a neutral verification membrane. The protocol is event-specific, non-persistent, transport-agnostic, and entity-agnostic, providing a timeless foundation for trust verification across all current and future technologies, entity types, and application contexts.

The invention builds upon the peer-to-peer sharing platform implementation disclosed in the parent application U.S. Ser. No. 17/085,257, generalizing that implementation to a universal protocol applicable to persons, devices, autonomous systems, organizations, and future constructs.

While the above description contains many specifics, these should not be construed as limitations on the scope of the invention, but rather as exemplifications of preferred embodiments thereof. Many other variations are possible within the scope of the appended claims.

1. A method for cryptographic trust verification between entities, comprising:
a first entity possessing a first cryptographic hash value derived from and inseparable from an identity of the first entity;
a second entity possessing a second cryptographic hash value derived from and inseparable from an identity of the second entity;
positioning a verification membrane between the first entity and the second entity, the verification membrane comprising an Encrypted Layered Authentication Intelligence (ELAI) verification layer that is a neutral positional space belonging to neither entity;
the first entity independently presenting the first cryptographic hash value to the verification membrane as part of a first verification event;
the second entity independently presenting the second cryptographic hash value to the verification membrane as part of the first verification event;
recording, by the verification membrane, receipt of each presented cryptographic hash value as an independent event record;
resolving, by the verification membrane, the first verification event to a verified state when both the first cryptographic hash value and the second cryptographic hash value are received for the first verification event and otherwise resolving the first verification event to an unverified state; and
enforcing an event-specific, non-persistent trust model in which each subsequent verification event between any entities begins from a default unverified state regardless of any prior verification history between the entities.

2. The method of claim 1, wherein the entities are any combination of natural persons, electronic devices, autonomous systems, organizations, artificial intelligence agents, vehicles, structures, biological constructs, or other constructs capable of holding and presenting a cryptographic hash value.

3. The method of claim 1, wherein the verification membrane operates across any transport medium including radio frequency communication, near-field communication, Bluetooth, optical signaling, acoustic signaling, network packet transport, direct electrical contact, or a future communication medium, without modification of verification logic executed by the verification membrane.

4. The method of claim 1, further comprising generating, for each verification event, an immutable attestation record comprising: the first cryptographic hash value, the second cryptographic hash value, the verified or unverified state, and a temporal marker, and storing the attestation record in an auditable chain of verification events.

5. The method of claim 1, wherein multiple verification events between a same pair of entities across time form a verification history, and wherein each verification event in the verification history is independently evaluated from the default unverified state such that no accumulation of prior verified states alters the default unverified state of any future verification event.

6. The method of claim 1, wherein the verification membrane performs hash resolution using a multi-layer counter-rotating cryptographic cipher comprising a plurality of symbol channels and a prime-indexed disruptor channel, the cipher being configured to collapse an indeterminate trust state between the entities into the verified state or the unverified state.

7. A system for entity-to-entity cryptographic verification, comprising:
a plurality of entities, each entity possessing a unique cryptographic hash value determined from an identity of the entity; and
a verification layer comprising an Encrypted Layered Authentication Intelligence (ELAI) module configured to be interposed between any two entities during a verification event, wherein the ELAI module is configured to:
receive, during a verification event, a first cryptographic hash value from a first entity and a second cryptographic hash value from a second entity;
record, in an event record, receipt of each cryptographic hash value as an independent submission;
output a binary verification result equal to a verified value when both cryptographic hash values are received for the verification event and equal to an unverified value otherwise; and
generate an attestation token that binds the first cryptographic hash value, the second cryptographic hash value, and the binary verification result to a timestamp associated with the verification event.

8. The system of claim 7, wherein the ELAI module is configured to operate without persistent centralized infrastructure such that each entity stores its own cryptographic hash value, and the ELAI module is instantiated at a point of interaction between any two entities using at least one communication channel available at a time of the verification event.

9. The system of claim 7, wherein the ELAI module is configured to:
implement the multi-layer counter-shifting cryptographic cipher to process the first and second cryptographic hash values; and
output the binary verification result as a deterministic function of positions of the cryptographic hash values within the cipher after counter-rotation.

10. The system of claim 7, wherein each verification event is constrained such that the binary verification result is not reusable as an authorization token outside the verification event, thereby preventing transfer of the binary verification result between unrelated transactions.

11. The method of claim 1, further comprising:
receiving, from a first mobile computing device associated with a first natural person, a transaction initiation request and presenting the first cryptographic hash value from the first mobile computing device to the verification membrane;
receiving, from a second mobile computing device associated with a second natural person, a transaction join request and presenting the second cryptographic hash value from the second mobile computing device to the verification membrane;
resolving, by the verification membrane, the verification event between the first and second natural persons to the verified state based on receipt of both cryptographic hash values; and
allowing a peer-to-peer resource-sharing transaction between the first natural person and the second natural person to proceed only when the verification event is in the verified state and without reliance on a third-party credit system, reputation score, or platform-controlled authorization.

12. The method of claim 1, wherein each cryptographic hash value is seeded at a time of creation of an entity identity by:
receiving raw identity data associated with the entity;
processing the raw identity data through the multi-layer counter-rotating cryptographic cipher to generate an intermediate symbol sequence; and
compressing the intermediate symbol sequence into the cryptographic hash value that is thereafter stored with and presented by the entity.

13. The method of claim 1, applied to physical proximity verification, comprising:
maintaining the first cryptographic hash value on a first mobile device associated with the first entity;
maintaining the second cryptographic hash value on a second mobile device associated with the second entity;
detecting co-presence of the first mobile device and the second mobile device within a defined proximity zone using at least one of Bluetooth Low Energy signaling, near-field communication, or optical code exchange;
automatically presenting both cryptographic hash values to the verification membrane in response to detecting the co-presence; and
resolving the verification event to the verified state only when the co-presence condition and presentation of both cryptographic hash values are satisfied.

14. The method of claim 1, wherein:
the first entity is a natural person;
the second entity is a physical asset that is assigned an asset-specific cryptographic hash value; and
resolving the verification event to the verified state authorizes a custody transfer of the physical asset from a first person-entity to a second person-entity, the custody transfer being recorded as one of the immutable attestation records.

15. The system of claim 7, wherein:
at least one entity corresponds to a user of a mobile ride-sharing or sharing-economy platform disclosed in a parent application; and
the attestation token generated by the ELAI module is stored in association with a platform transaction record describing at least one of a ride, a rental, or a peer-to-peer exchange implemented by a backend server.

16. The method of claim 1, wherein the first entity and the second entity are autonomous systems configured to present the first and second cryptographic hash values to the verification membrane without human initiation, thereby establishing machine-to-machine trust for an automated interaction.

17. The method of claim 1, wherein the first entity and the second entity are organizations, and wherein the verified state represents a bilateral institutional trust event analogous to a contract or treaty and is recorded as an attestation record in a shared audit ledger.

18. The system of claim 7, wherein the system is configured to maintain validity of cryptographic hash values and verification logic across multiple generations of transport technologies such that cryptographic hash values generated using a first transport technology remain verifiable when entities communicate using a later transport technology without re-issuing the cryptographic hash values.

19. The method of claim 1, wherein the verification membrane is implemented as executable logic on at least one of:
a backend server in communication with the first entity and the second entity over a data network;
distributed protocol logic executing on devices associated with the first entity and the second entity in a peer-to-peer architecture; or
a smart contract on a distributed ledger accessible to both entities.

20. The system of claim 7, wherein the ELAI module further comprises:
a configurable temporal window defining a maximum time interval within which both cryptographic hash values must be received for the verification event to resolve to the verified value; and
logic to reject hash presentations received outside the temporal window, thereby ensuring temporal binding of the verification event.
